(19) United States
(12) Patent Application Publication
(10) Pub. No.: US 2013/0018558 A1
(43) Pub. Date: Jan. 17, 2013

(54) VEHICLE CONTROL APPARATUS AND METHOD USING VISIBLE LIGHT COMMUNICATION

(71) Applicant: Byoung Suk Ahn, Suwon-si (KR)

(72) Inventor: Byoung Suk Ahn, Suwon-si (KR)

(73) Assignee: Hyundai Motor Company, Seoul (KR)

(21) Appl. No.: 13/299,072

(22) Filed: Nov. 17, 2011

(30) Foreign Application Priority Data
Jul. 14, 2011 (KR) 10-2011-0070019

(51) Int. Cl. B60T 7/12; G06F 19/00

(52) U.S. Cl. 701/70

(57) ABSTRACT

A vehicle control apparatus of a vehicle using a visible light communication may include a visible light receiving unit configured to periodically receive a speed information of a preceding vehicle through the visible light communication, a sudden deceleration detection unit configured to detect a sudden deceleration of the preceding vehicle based on the speed information received from the visible light receiving unit, a control unit configured to control a brake system linkage unit to transmit a deceleration signal to a brake system, upon detection of the sudden deceleration of the preceding vehicle by the sudden deceleration detection unit, and the brake system linkage unit configured to transmit the deceleration signal to the brake system to automatically decelerate a speed of the vehicle.

### CROSS-REFERENCES TO RELATED APPLICATIONS

The present application claims priority to Korean Patent Application No. 10-2011-0070019, filed on Jul. 14, 2011, the entire contents of which is incorporated herein for all purposes by this reference.

### BACKGROUND OF THE INVENTION

1. Field of the Invention

The present invention relates to an apparatus and a method for vehicle control using visible light communication, and more particularly, to an apparatus and a method for vehicle control using visible light communication, in which a vehicle is controlled based on driving information obtained from a preceding vehicle by using the visible light communication.

2. Description of Related Art

A visible light is an electromagnetic radiation of which wavelength is in a visible range, i.e., 380 nm to 780 nm. Depending on a wavelength, a radiation is seen in different colors and a visible light spectrum ranges from red (longer wavelength) at one end to violet (shorter wavelength) at the other end. A radiation having a longer wavelength than a red light is called an infrared light and a radiation having a shorter wavelength than a violet light is called an ultraviolet light.

In case of a monochromatic light, a wavelength of 610 nm˜700 nm corresponds to a red light, a wavelength of 590 nm˜610 nm corresponds to an orange light, a wavelength of 570 nm˜590 nm corresponds to a yellow light, a wavelength of 500 nm˜570 nm corresponds to a green light, a wavelength of 450 nm˜500 nm corresponds to a blue light, and a wavelength of 400 nm˜450 nm corresponds to a violet light.

Communication technologies using a light includes, but not limited to, an infrared range wireless communication (IrDA) using the infrared light, a visible light wireless communication using the visible light, and an optical communication using an optical fiber.

Among these technologies, the visible light wireless communication using the visible light is distinct from other wireless communication methods in that a signal for transmitting a communication data can be recognized by human eyes.

The visible light communication is a communication technology using a wavelength in a range of 380 nm˜780 nm, and a standardization of the visible light communication is being developed by IEEE 802.15 “Study Group” for wireless personal area network (WPAN). Also, in Korea, a visible light communication practice team is operated in the Information and Communication Technology Association (TTA).

Recently, the visible light communication is applied to a vehicle, and there exists a need for a technology that can promote driver's safe driving by using the visible light communication.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus and a method for vehicle control by using visible light communication in which a vehicle is controlled based on driving information obtained from a preceding vehicle by using the visible light communication.

Namely, the present invention provides an apparatus and a method for vehicle control by using visible light communication in which, upon detection of sudden deceleration of a preceding vehicle based on speed information obtained from the preceding vehicle through visible light communication, a brake system is linked to automatically control braking of a vehicle.

According to one aspect of the present invention, the vehicle control apparatus of a vehicle using a visible light communication, may include a visible light receiving unit configured to periodically receive a speed information of a preceding vehicle through the visible light communication, a sudden deceleration detection unit configured to detect a sudden deceleration of the preceding vehicle based on the speed information received from the visible light receiving unit, a control unit configured to control a brake system linkage unit to transmit a deceleration signal to a brake system, upon detection of the sudden deceleration of the preceding vehicle by the sudden deceleration detection unit, and the brake system linkage unit configured to transmit the deceleration signal to the brake system to automatically decelerate a speed of the vehicle.

A deceleration may be determined as the sudden deceleration when a deceleration gradient in a time period may be greater than a predetermined value.

The vehicle control apparatus may further include a visible light transmitting unit configured to transmit a speed information of the vehicle to a following vehicle by using the visible light communication.

The control unit may be configured to control the visible light transmitting unit to transmit the speed information of the vehicle to the following vehicle.

The control unit may be configured to control the visible light transmitting unit to transmit the speed information of the vehicle to the following vehicle, wherein the control unit may be configured to control the visible light transmitting unit to transmit an illumination light according to an external illumination signal, and wherein the speed information of the vehicle may have priority over the illumination signal of the vehicle.

In another aspect of the present invention, a vehicle control method using a visible light communication, may include periodically receiving a speed information of a preceding vehicle through the visible light communication, detecting a sudden deceleration of the preceding vehicle based on the received speed information, and transmitting a deceleration signal to a brake system upon detection of the sudden deceleration of the preceding vehicle to reduce a speed of a vehicle.

The vehicle control method may further include transmitting a speed information of a vehicle to a following vehicle by using the visible light communication.

The vehicle control method may further include transmitting an illumination light.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a configuration of a vehicle control apparatus using visible light communication according to an exemplary embodiment of the present invention.

FIG. 2 illustrates a configuration of a visible light receiving unit according to an exemplary embodiment of the present invention.

FIG. 3 illustrates a configuration of a visible light transmitting unit according to an exemplary embodiment of the present invention.

FIG. 4 is a flowchart diagram illustrating a vehicle control method using visible light communication according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

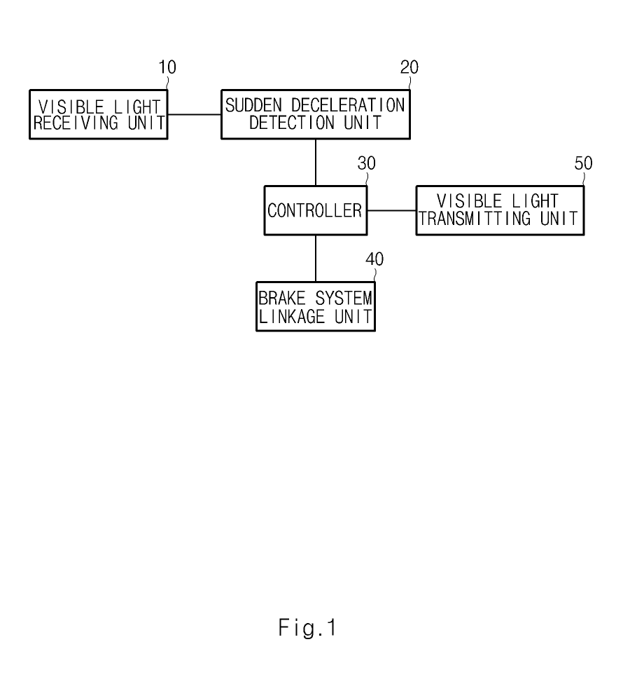

FIG. 1 illustrates a configuration of a vehicle control apparatus using visible light communication according to an exemplary embodiment of the present invention.

As shown in FIG. 1, the vehicle control device using visible light communication according to the exemplary embodiment of the present invention includes a visible light receiving unit 10, a sudden deceleration detection unit 20, a controller 30, a brake system linkage unit 40, and a visible light transmitting unit 50.

Each element will be described. First, the visible light receiving unit 10 periodically receives speed information of a preceding vehicle from a tail light of the preceding vehicle through visible light communication.

The sudden deceleration detection unit 20 detects sudden deceleration of the preceding vehicle based on the speed information received from the visible light receiving unit 10. In other words, the sudden deceleration detection unit 20 may detect when the preceding vehicle suddenly decelerates by calculating the gradient of the deceleration in a predetermined time period. For example, when the preceding vehicle decelerates from 100 Km/h to 80 km/h in one second, the sudden deceleration detection unit 20 can detect this as sudden deceleration.

Upon detection of the sudden deceleration of the preceding vehicle by the sudden deceleration detection unit 20, the controller 30 transmits a deceleration signal to the brake system linkage unit 40 to automatically decelerate a speed of a vehicle, which employs the vehicle control apparatus.

In addition, the controller 30 transmits speed information of the vehicle to a following vehicle through the visible light transmitting unit 50 to aid in safe operation of the following vehicle.

The brake system linkage unit 40 automatically controls the vehicle's speed in conjunction with a brake system of the vehicle (e.g., ABS systems).

The visible light transmitting unit 50 transmits the speed information of the vehicle to the following vehicle through the visible light communication.

Additionally, a display unit can be further included to provide a driver with the speed information of the preceding vehicle in real time.

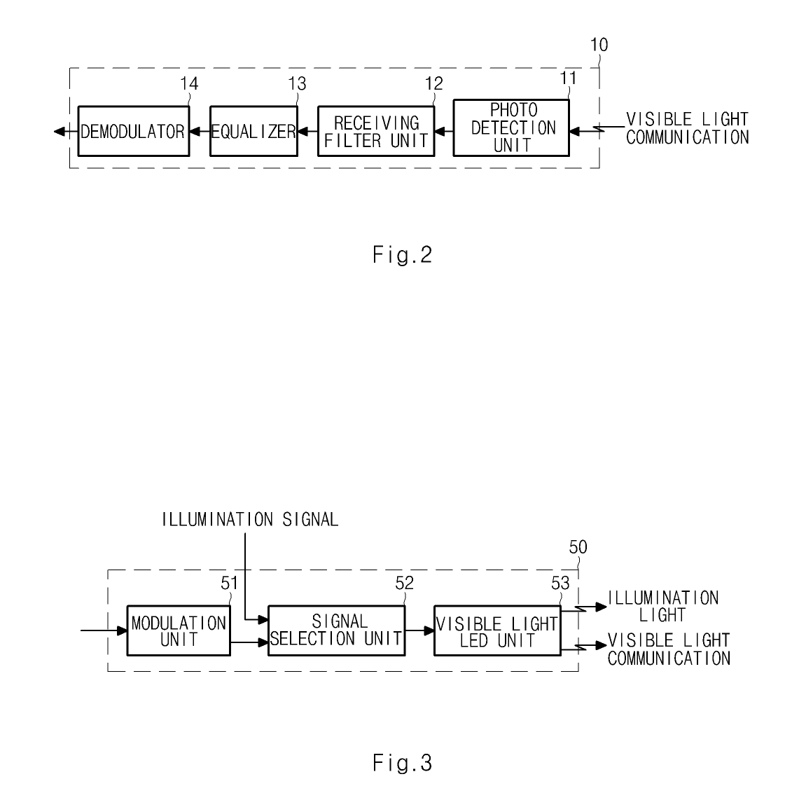

With reference to FIG. 2, the visible light receiving unit 10 is described in detail below.

As shown in FIG. 2, the visible light receiving unit 10 includes a photo detection unit 11 a receiving filter unit 12, an equalizer 13, and a demodulator 14.

The photo detection unit 11 converts an optical signal received from the preceding vehicle into an electric signal through the visible light communication to be outputted. Namely, the photo detection unit 11 is a type of semiconductor diode that generates a current corresponding to an optical signal.

The receiving filter unit 12 removes a carrier wave component from an electrical signal having a particular frequency band outputted from the photo detection unit 11, and performs a correlation processing based on a reference code to output a signal.

The equalizer 13 compensates the signal outputted from the receiving filter unit 12 and outputs the compensated signal. The equalizer 13 has a feature and a function similar or the same as those used in various wireless communication systems, and thus, a detailed description thereof is omitted.

The demodulator 14 demodulates the signals outputted from the equalizer 13 according to various demodulation schemes to output the driving information. Here, the demodulator 14 can carry out demodulation by using a demodulation scheme corresponding to one of modulation schemes including, but not limited to, on off keying (OOK), pulse width modulation (PWM), pulse position modulation (PPM), pulse amplitude modulation (PAM), amplitude shift keying (ASK), m-ary phase shift keying (M-PSK), and m-ary quadrature amplitude modulation (M-QAM).

With reference to FIG. 3, the visible light transmitting unit 50 is described in more detail below.

As shown in FIG. 3, the visible light transmitting unit 50 includes a modulation unit 51, a signal selection unit 52 and a visible light LED unit 53.

The modulation unit 51 modulates the driving information of the vehicle onto a carrier wave having a particular frequency band. Here, the modulation unit 51 performs modulation by using one of modulation schemes including, but not limited to, OOK, PWM, PPM, PAM, ASK, M-PSK, and M-QAM.

The visible light transmitting unit 50 corresponds to a rear lamp of a vehicle, and thus is required to perform a basic illumination function. In other words, when there is a need for an illumination function, the visible light transmitting unit 50 outputs an illumination light according to an external illumination signal.

The signal selection unit 52 selects an illumination signal for performing the illumination function and the driving information for performing the visible light communication and outputted a selected signal. In other words, the signal selection unit 52 selects one of the illumination signal externally inputted and a modulated signal of the modulation unit 51. Here, when the modulated signal is inputted from the modulation unit 51, the signal selection unit 52 transmits the modulated signal, which has a priority over the illumination signal, to the visible light LED unit 53.

The visible light LED unit 53 includes at least one light emitting diode (LED) that converts an electrical signal into an optical signal in a visible light region and outputs a visible light signal corresponding to a signal outputted from the signal selection unit 52.

Thus, when the illumination signal for performing the illumination function is selected by the signal selection unit 52, the visible light LED unit 53 serves as a lighting source, and when the driving information for performing the visible light communication is selected by the signal selection unit 52, the visible light LED unit 53 serves as a lighting source for performing the visible light communication.

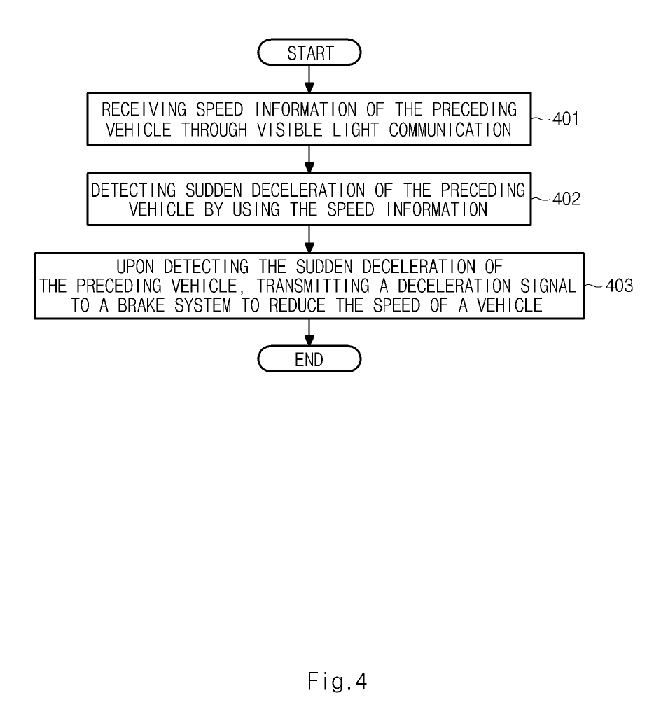

FIG. 4 is a flowchart diagram illustrating a vehicle control method using visible light communication according to an exemplary embodiment of the present invention.

First, the visible light receiving unit 10 periodically receives the speed information of the preceding vehicle through visible light communication (401).

Next, the sudden deceleration detection unit 20 detects the sudden deceleration of the preceding vehicle by using the speed information received through the visible light receiving unit 10 (402).

Next, upon detecting the sudden deceleration of the preceding vehicle by the sudden deceleration detection unit 20, the controller 30 transmits the deceleration signal to the brake system through the brake system linkage unit 40 to reduce the speed of the vehicle (403).

Through this process, an auto accident can be prevented from occurring due to sudden deceleration of the preceding vehicle.

As described above, according to an exemplary embodiment of the present invention, a vehicle is controlled based on driving information obtained from the preceding vehicle through visible light communication, thereby improving driver's safety while driving.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle control apparatus of a vehicle using a visible light communication, the vehicle control apparatus comprising:
a visible light receiving unit configured to periodically receive a speed information of a preceding vehicle through the visible light communication;
a sudden deceleration detection unit configured to detect a sudden deceleration of the preceding vehicle based on the speed information received from the visible light receiving unit;
a control unit configured to control a brake system linkage unit to transmit a deceleration signal to a brake system, upon detection of the sudden deceleration of the preceding vehicle by the sudden deceleration detection unit; and
the brake system linkage unit configured to transmit the deceleration signal to the brake system to automatically decelerate a speed of the vehicle.

2. The vehicle control apparatus according to claim 1, wherein a deceleration is determined as the sudden deceleration when a deceleration gradient in a time period is greater than a predetermined value.

3. The vehicle control apparatus according to claim 1, further comprising:
a visible light transmitting unit configured to transmit a speed information of the vehicle to a following vehicle by using the visible light communication.

4. The vehicle control apparatus according to claim 3, wherein the control unit is configured to control the visible light transmitting unit to transmit the speed information of the vehicle to the following vehicle.

5. The vehicle control apparatus according to claim 4, wherein the control unit is configured to control the visible light transmitting unit to transmit an illumination light according to an external illumination signal.

6. The vehicle control apparatus according to claim 5, wherein the speed information of the vehicle has priority over the illumination signal of the vehicle.

7. The vehicle control apparatus according to claim 3, wherein the control unit is configured to control the visible light transmitting unit to transmit an illumination light.

8. A vehicle control method using a visible light communication, the vehicle control method comprising:
periodically receiving a speed information of a preceding vehicle through the visible light communication;
detecting a sudden deceleration of the preceding vehicle based on the received speed information; and
transmitting a deceleration signal to a brake system upon detection of the sudden deceleration of the preceding vehicle to reduce a speed of a vehicle.

9. The vehicle control method according to claim 8, further comprising:
transmitting a speed information of a vehicle to a following vehicle by using the visible light communication.

10. The vehicle control method according to claim 8, further comprising:
transmitting an illumination light.
